(19) United States
(12) Patent Application Publication
(10) Pub. No.: US 2012/0293596 A1
(43) Pub. Date: Nov. 22, 2012

(54) MULTIPLE BEAM ROS WITH ADJUSTABLE SWATH WIDTH AND SPACING USING ADJUSTABLE OPTICAL DEVICE

(75) Inventors: Jonathan B. Hunter, Marion, NY (US); David Robert Kretschmann, Webster, NY (US); David Mark Kerxhalli, Rochester, NY (US); Ronald W. Bogert, Webster, NY (US)

(73) Assignee: XEROX CORPORATION, Norwalk, CT (US)

(21) Appl. No.: 13/109,447

(22) Filed: May 17, 2011

(51) Int. Cl. B41J 2/47; G02B 26/08

(52) U.S. Cl. 347/256; 359/216.1

(57) ABSTRACT

Multiple beam raster output scanners (ROSs) and printing systems are presented in which an adjustable mirror or lens is provided in the optical beam path upstream of the ROS polygon mirror to allow automated electronic adjustment of line-to-line and swath-to-swath spacing at runtime.

### BACKGROUND AND INCORPORATION BY REFERENCE

The present exemplary embodiment relates to multiple beam raster output scanning devices (ROSs) and printers, copiers, and other document processing systems using one or more ROSs providing multiple scanned beam lines. Xerographic printing systems use one or more ROSs to project the laser scan line onto a photoreceptor such as a photosensitive plate, belt, or drum, for xerographic printing. The ROS provides a laser beam which switches on and off as it moves or scans across the photoreceptor to form a desired image thereon. The beam is selectively interrupted according to image data in order to create a latent image on the precharged photoreceptor surface, and a developer deposits toner onto the latent image to create a toner image that is thereafter transferred and fused to a final print medium, such as a printed sheet. Multiple beam ROSs concurrently scan multiple light beams onto the photoreceptor, using an array of lasers or other light sources to provide multiple beam lines to a rotating polygon having mirrored facets that create a set of parallel scan lines, sometimes referred to as a swath. Advanced printing systems have been proposed in which 32 individual scan lines are formed in each swath scanned across a photoreceptor belt in a fast scan direction as the photoreceptor moves in a perpendicular process direction. This wide swath of scan lines leads to various difficulties in controlling image quality, due to required synchronization and coordination between the process direction speed of the photoreceptor (e.g., belt or drum speed), the rotational velocity of the polygon, and the spacing between individual scan lines provided by the ROS.

In order to mitigate visually perceptible errors, it is desirable to control the scan line well as swath-to-swath spacing in the process direction at the photoreceptor, which are a function of the photoreceptor and polygon speeds. In certain ROS systems, moreover, scan line overwriting is used, in which consecutive swaths of scan lines are partially overwritten, for example, where line one of scan N+1 overlaps line 17 of scan n. Such overwriting may advantageously allow balancing of laser power and overall smoothing of a scanned image. However, interactions between scan line spacing and swath-to-swath spacing may lead to stitch error, causing undesirable image artifacts. In particular, both scan line spacing (as a function of swath width) and swath-to-swath spacing (as a function of photoreceptor velocity and polygon speed) contribute to stitch error. Too little spacing between swaths will cause bunching, while too much spacing will result in excess non-imaged area between the swaths. Either of these conditions can lead to image artifacts such as banding and beating.

Conventionally, the spacing issues could be addressed in the initial manufacturing setup steps, as well as in field calibration at runtime, by adjustment of photoreceptor process direction speed and/or with adjustments to the speed of the rotating polygon. However, many systems do not provide for adjustability in photoreceptor speed, particularly after a printer has been commissioned in the field (no runtime adjustment). Thus, a need remains for improved ROS systems and printers by which runtime compensation for swath to swath and scan line spacing can be achieved.

Stowe U.S. Pat. No. 7,542,200, issued Jun. 2, 2009 describes an agile beam steering mirror for active raster scan error correction, in which bow affects are corrected by periodic rotation of a beam steering mirror assembly in synchronization with the motion of a polygon mirror scanner, the entirety of which is hereby incorporated by reference. Appel U.S. Pat. No. 6,232,991, issued May 15, 2001 and assigned to the Assignee of the present application, describes a ROS adjustment technique using a tiltable scan lens for correcting bow errors by tilting a second scan lens along a fast scan axis using a threaded adjustment screw, the entirety of which is hereby incorporated by reference. Genovese U.S. Pat. No. 5,153,608, issued Oct. 6, 1992 and assigned to the Assignee of the present application, discloses an electrophotographic printer or image scanner in which a translucent Lucite or Plexiglas optical element is positioned along a line of beam scanning and is twisted for skew and bow correction, the entirety of which is hereby incorporated by reference.

### BRIEF DESCRIPTION

The disclosure provides improved printing systems and multiple beam raster output scanners (ROSs) therefor, in which one or more beam path optical elements such as mirrors or lenses are adjustable at runtime to set the spacing between adjacent scan lines. This allows runtime variation in the scan swath width and line spacing by which stitching error and other problems can be mitigated or eliminated without requiring adjustment of the photoreceptor velocity.

One or more aspects of the disclosure relate to a ROS having a multibeam light source which concurrently provides a plurality of light beams to a first optical system that collimates the light beams. The ROS further includes a rotating polygon with mirrored facets that concurrently deflect the collimated light beams received from the first optical system. A second optical system then focuses the deflected light beams from the polygon into a plurality of moving spots and directs the spots towards a photoreceptor traveling in a process direction. An adjustable mirror is provided, having a reflective surface that is positioned in the optical system to deflect the light beams, along with an electronic adjustment input to change the position and/or shape of the reflective surface so as to increase or decrease the spacing between adjacent light beams in the process direction at the photoreceptor. The ROS or the system generally includes a controller to provide an electronic signal or value to the electronic adjustment input at runtime, and the controller holds the signal or value constant while the polygon rotates in order to set the beam spacing.

In certain embodiments, the adjustable mirror is situated in the first optical system along the beam path between the light source and the polygon. The reflective surface in certain embodiments is bowed, such as a convex reflective surface in some implementations, and the electronic adjustment input modifies the bowed shape or position in order to change the beam spacing, thereby allowing adjustment of line-to-line, and swath-to-swath spacing.

In accordance with further aspects of the disclosure, a multiple beam ROS is provided in which the first optical system between the light source and the polygon includes an adjustable lens with an electronic adjustment input to change the position of the lens in order to increase or decrease the spacing between adjacent light beams in the process direction at the photoreceptor. In some embodiments, the adjustable lens includes a motor operatively coupled with the lens to change an incident angle at which the light beams arrive at the lens from the light source. In other embodiments, the adjustable lens includes a linear actuator to change the distance between the lens and the light source along the path of the light beams in order to change the spacing between adjacent beams in the process direction at the photoreceptor.

Further aspects of the disclosure are directed to a printing system, which includes a photoreceptor moving in a process direction at a fixed speed, as well as a charging station which charges an exterior surface of an image area of the photoreceptor. The system also includes one or more raster output scanners to produce scan lines in a fast scan direction that is substantially perpendicular to the process direction. The raster output scanner includes a light source that concurrently emits a plurality of light beams, along with an optical system and a controller. The optics includes a first optical system to collimate the light beams received from the light source. The first optical system includes an adjustable optical element operative to increase or decrease the spacing between adjacent light beams in the process direction at the photoreceptor. In some embodiments, the adjustable optical element is a mirror with a reflective surface positioned in the first optical system to deflect the light beams, and an electronic adjustment input to change the position and/or shape of the reflective surface to increase or decrease the light beam spacing. In other embodiments, the adjustable optical element is an adjustable lens with an input to change the position of the lens to modify the deflected light beam spacing in the process direction at the photoreceptor.

### BRIEF DESCRIPTION OF THE DRAWINGS

The present subject matter may take form in various components and arrangements of components, as well as in various steps and arrangements of steps. The drawings are only for purposes of illustrating preferred embodiments and are not to be construed as limiting the subject matter.

FIG. 1 is a simplified schematic diagram illustrating an exemplary multi-colored document processing system with a plurality of selectively adjustable ROSs in which one or more aspects of the disclosure may be implemented;

FIG. 2 is a partial top plan view illustrating a portion of the exemplary photoreceptor belt in the system of FIG. 1 with image panels separated by inter panel zones;

FIG. 3 is a simplified schematic diagram illustrating an exemplary ROS with an adjustable optical element between a laser array light source and a rotating polygon that may be used to increase or decrease spacing between adjacent light beams at the photoreceptor in accordance with one or more aspects of the present disclosure;

FIG. 4 is a partial top plan view illustrating a portion of a photoreceptor belt showing scan lines created by a conventional dual beam raster output scanner;

FIG. 5 is a partial top plan view illustrating a portion of a photoreceptor belt with 32 scan lines created by a multiple beam raster output scanner using a vertical cavity surface emitting laser (VCSEL) light source in the system of FIG. 1;

FIG. 6 is a partial top plan view strating a portion of the photoreceptor belt in the system of FIG. 1, showing adjacent 32 line scan swaths and the corresponding swath-to-swath spacing;

FIG. 7 is a partial top plan view illustrating a portion of the photoreceptor belt with overwritten 32 line scan swaths in which scan line 1 of a given swath overwrites scan line 17 of the preceding swath;

FIG. 8 is a partial side elevation view illustrating first and second (pre and post-polygon) optical systems and a rotating polygon in an exemplary ROS of the system of FIG. 1, including on adjustable mirror in the first optical system between the laser array light source and the polygon;

FIGS. 9 and 10 are partial side elevation views illustrating further details of one implementation of the adjustable mirror of FIG. 8 in two operational positions;

FIG. 11 is a partial side elevation view illustrating another exemplary ROS in the system of FIG. 1, having an adjustable lens in the first optical system; and

FIGS. 11 and 12 are partial side elevation views illustrating exemplary rotational and linear lens adjustment mechanisms in the ROS of FIG. 11.

### DETAILED DESCRIPTION

Referring now to the drawing figures, several embodiments or implementations of the present disclosure are hereinafter described in conjunction with the drawings, wherein like reference numerals are used to refer to like elements throughout, and wherein the various features, structures, and graphical renderings are not necessarily drawn to scale. The disclosure relates to provision of adjustable optical elements in a multibeam ROS allowing run-time adjustment of beam line to beam line spacing to avoid or mitigate stitching and related problems, where the disclosed systems and techniques are particularly advantageous in systems in which a process direction photoreceptor translation speed is fixed. The adjustment mechanisms disclosed herein can be used to reduce such errors in both manufacturing situations, as well as those calibration or configuration steps undertaken in the field. Moreover, the adjustment apparatus is electronically set, whereby such adjustment may be undertaken automatically under direction of a machine controller.

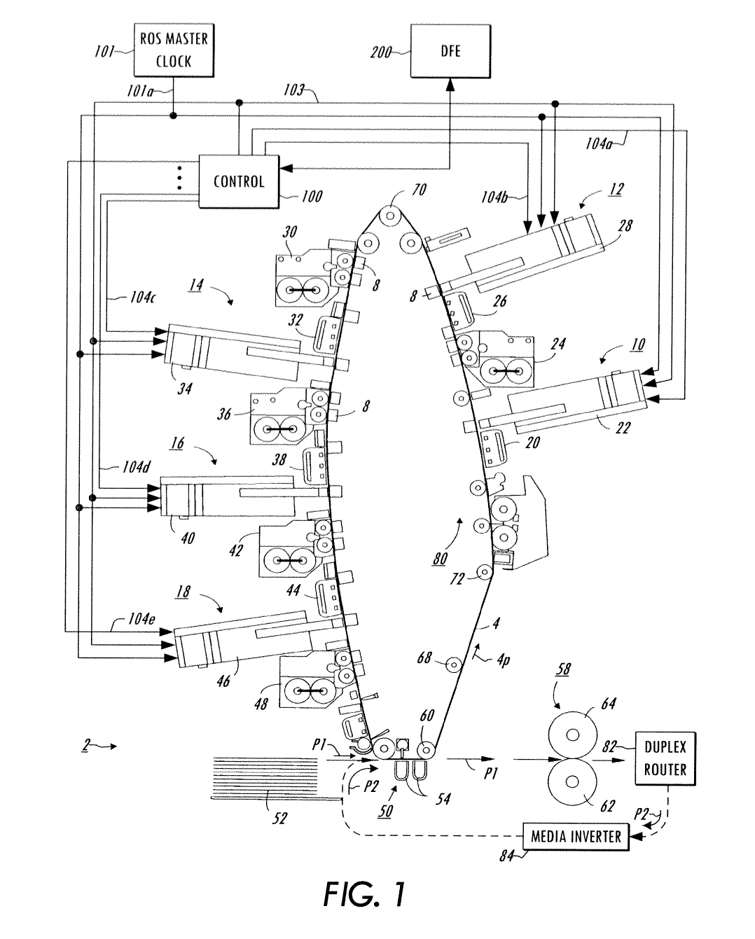

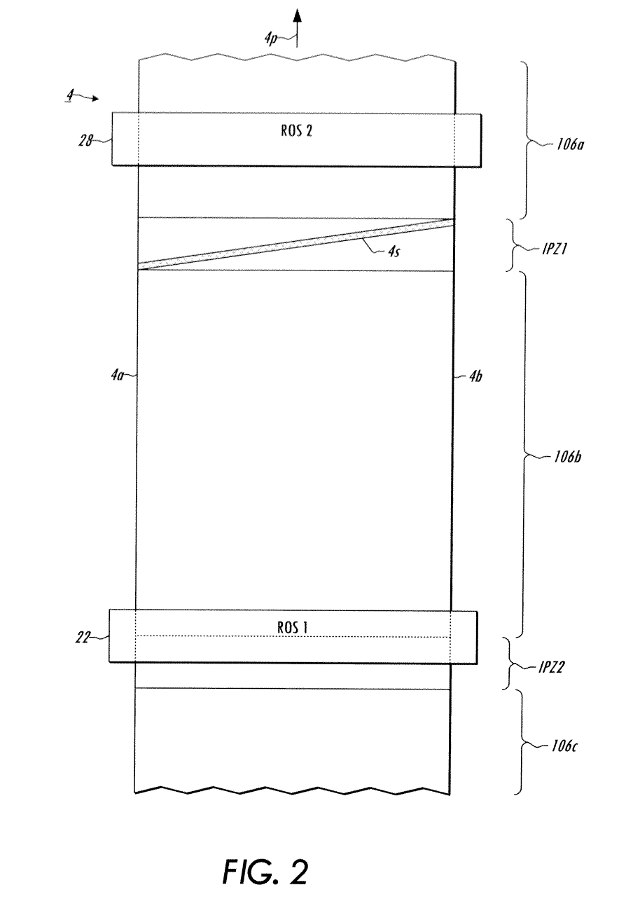

FIGS. 1 and 2 illustrate an exemplary multi-color xerographic document processing system 2 including a continuous photoconductive (e.g., photoreceptor) imaging belt or intermediate transfer belt (ITB) 4 with first and second lateral sides 4a and 4b (FIG. 2). The photoreceptor 4 traverses a closed path 4p in a process direction indicated by the path arrow 4p in the figures (counterclockwise in the view of FIG. 1) via a drive assembly 80 having a series of rollers 60, 68, 70 or bars 8 at a substantially constant speed to move successive portions of its outer photoconductive surface sequentially beneath the various xerographic processing stations disposed about the path 4p in the system 2. The system 2 includes raster output scanners (ROSs) 22, 28, 34, 40, 46 located along the closed path 4p of the photoreceptor 4, which are individually operable to generate a latent image on a portion of the photoreceptor 4. In addition, a plurality of developers 24, 30, 36, 42, 48 are individually located downstream of a corresponding one of the ROSs 22, 28, 34, 40, 46 to develop toner of a given color on the latent image on the photoreceptor 4.

A transfer station 50 is located along the path 4p downstream of the ROSs 22, 28, 34, 40, 46 (at the bottom in FIG. 1) to transfer the developed toner from the photoreceptor 4 to a substrate 52 traveling along a first substrate path P1, and a fusing station 58 with rollers 62 and 64 fixes the transferred toner to the substrate 52. For two-sided printing, a duplex router 82 receives the substrate 52 from the fusing station 58 and selectively directs the substrate 52 along a second path P2, and a media inverter 84 located along the second path inverts the substrate 52 and returns the inverted substrate 52 to the first path P1 upstream of the transfer station 50 for selectively producing images on the second sides of certain substrate sheets.

The system 2 also includes a ROS master clock 101 providing a clock output signal 101a to the ROSs 22, 28, 34, 40 and 46, where the clock output signal 101a can be an analog value or a digital value indicating a frequency or clock speed or other signals or values by which the ROS motor polygon assembly (MPA) operational speed can be set or adjusted, either dynamically using a controller 100 during operation, or which can be preset, for example, during system calibration or initial manufacturing. The controller 100 may be any suitable form of hardware, processor-executed software, firmware, programmable logic, or combinations thereof, whether unitary or implemented in distributed fashion in a plurality of components, wherein all such implementations are contemplated as falling within the scope of the present disclosure and the appended claims. The controller 100 provides data and one or more control signal(s) or command(s) to the individual ROSs 22, 28, 34, 40 and 46 based on image data to be provided thereto. In particular, the controller 100 provides at least one electronic signal or value 104 to each ROS to set the line-to-line spacing in the process direction 4p as detailed further below.

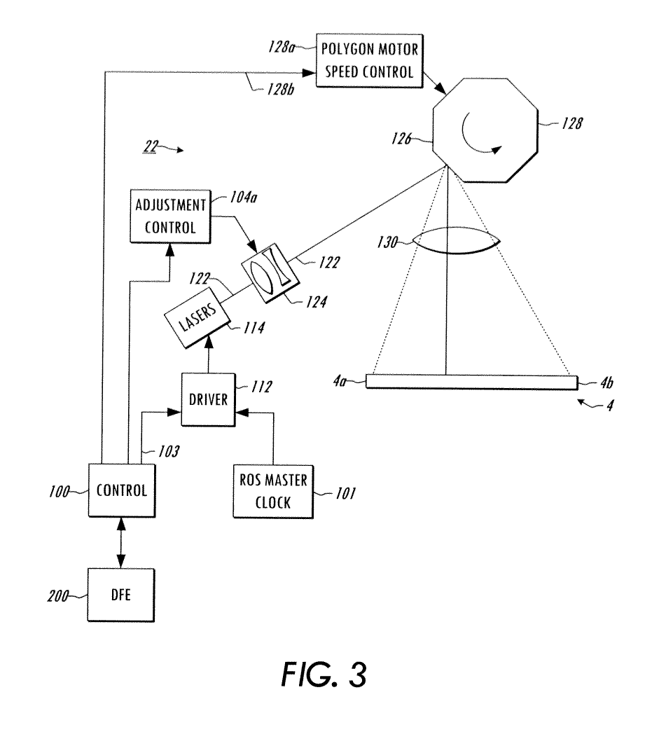

The photoreceptor 4 passes through a first charging station 10 that includes a charging device such as a corona generator 20 that charges the exterior surface of the belt 4 to a relatively high, and substantially uniform potential. The charged portion of the belt 4 advances to a first ROS 22 which image-wise illuminates the charged belt surface to generate a first electrostatic latent image thereon, where FIG. 3 schematically illustrates further details of the exemplary first ROS device 22 as representative of the other ROSs in the system 2. The first electrostatic latent image is developed by developer unit 24 (FIG. 1) that deposits charged toner particles of a selected first color on the first electrostatic latent image. Once the toner image has been developed, the imaged portion of the photoreceptor 4 advances to a recharging station 12 that recharges the photoreceptor surface, and a second ROS 28 image-wise illuminates the charged portion of the photoreceptor 4 to generate a second electrostatic latent image corresponding to the regions to be developed with toner particles of a second color. The second latent image then advances to a subsequent developer unit 30 that deposits the second color toner on the latent image to form a colored toner powder image of that color on the photoreceptor 4.

The photoreceptor 4 then continues along the path 4p to a third image generating station 14 that includes a charging device 32 to recharge the photoreceptor 4 and a ROS exposure device 34 which illuminates the charged portion to generate a third latent image. The photoreceptor 4 proceeds to the corresponding third developer unit 36 which deposits toner particles of a corresponding third color on the photoreceptor 4 to develop a toner powder image, after which the photoreceptor 4 continues on to a fourth image station 16. The fourth station 16 includes a charging device 38 and a ROS exposure device 40 at which the photoreceptor 4 is again recharged and a fourth latent image is generated, respectively, and the photoreceptor 4 advances to the corresponding fourth developer unit 42 which deposits toner of a fourth color on the fourth latent image. The photoreceptor 4 then proceeds to a fifth station 18 that includes a charging device 44 and a ROS 46, followed by a fifth developer 48 for recharging, generation of a fifth latent image, and development thereof with toner of a fifth color.

Thereafter, the photoconductive belt 4 advances the multi-color toner powder image to the transfer station 50 at which a printable medium or substrate, such as paper sheet 52 in one example is advanced from a stack or other supply via suitable sheet feeders (not shown) and is guided along a first substrate media path P1. A corona device 54 sprays ions onto the back side of the substrate 52 that attracts the developed multi-color toner image away from the belt 4 and toward the top side of the substrate 52, with a stripping axis roller 60 contacting the interior belt surface and providing a sharp bend such that the beam strength of the advancing substrate 52 strips from the belt 4. A vacuum transport or other suitable transport mechanism (not shown) then moves the substrate 52 along the first media path P1 toward the fusing station (fuser) 58. The fusing station 58 includes a heated fuser roller 64 and a back-up roller 62 that is resiliently urged into engagement with the fuser roller 64 to form a nip through which the substrate 52 passes. In the fusing operation at the station 58, the toner particles coalesce with one another and bond to the substrate to affix a multi-color image onto the upper (first) side thereof.

While the multi-color developed image has been disclosed as being transferred from the photoreceptor belt 4 to the substrate 52, in other possible embodiments, the toner may be transferred to an intermediate member, such as another belt or a drum, and then subsequently transferred and fused to the substrate 52. Moreover, while toner powder images and toner particles have been disclosed herein, one skilled in the art will appreciate that a liquid developer material employing toner particles in a liquid carrier may also be used, and that other forms of marking materials may be employed, wherein all such alternate embodiments are contemplated as falling within the scope of the present disclosure.

For single-side printing, the fused substrate 52 continues on the first path P1 to be discharged to a finishing station (not shown) where the sheets are compiled and formed into sets which may be bound to one another and can then be advanced to a catch tray for subsequent removal therefrom by an operator or user. For two-sided printing, the system 2 includes a duplex router 82 that selectively diverts the printed substrate medium 52 along a second (e.g., duplex bypass) path P2 to a media inverter 84 in which the substrate 52 is physically inverted such that a second side of the substrate 52 is presented for transfer of marking material in the transfer station 50.

Referring also to FIG. 2, the photoreceptor belt 4 includes multiple image panel zones 102 in which the ROSs 22, 28, 34, 40, and 46 generate latent images, where three exemplary panel zones 106a-106c are illustrated in the partial view of the figure. Any number of panels 106 may be defined along the circuitous length of the photoreceptor 4, and the number may change dynamically based on the size of the printed substrates 52 being fed to the transfer mechanism 50, where the illustrated belt 4 includes about 11 such zones 106 for letter size paper sheet substrates 52. The panel zones 106 are separated from one another by inter panel zones IPZ, where two exemplary inter-panel zones IPZ1 and IPZ2 are shown in FIG. 2, with IPZ1 being defined in a portion of the belt 4 that includes a belt seam 4s.

Referring also to FIG. 3, the controller 100 provides the individual ROSs 22, 28, 34, 40, and 46 with one or more adjustment control signals or values 104 (104a for ROS 22, 104b for ROS 28, etc.) at runtime to set the spacing between adjacent scan lines 400 of the corresponding ROS, and the controller 100 holds these adjustment inputs 104 fixed while the ROSs are operating. Between jobs, or during on-site adjustment or calibration operations, the controller 100 can change the adjustment input signals or values 104a-104f individually or as a group to increase or decrease the scan line spacing and swath spacings. The adjustment can be done automatically based on feedback or measured performance metrics (e.g., machined-sensed banding or stitching problems) and/or under direction from a user. In this regard, the calibration steps may include adjustment to a photoreceptor speed, and an operator can set the adjustment input signals or values 104a-104f to adjust the ROS line spacing and swath spacing accordingly to mitigate or avoid stitching or other errors. Based on the adjustment inputs 104, the ROSs 22, 28, 34, 40, and 46 individually tune an internal adjustable optical element, such as a mirror or a lens in the optical beam path to set the resulting line and swath spacing in the process direction seen at the photoreceptor.

FIG. 3 shows further details of the first ROS 22, wherein the other ROSs 28, 34, 40, and 46 in the exemplary system 2 are similarly constructed. The ROS 22 includes a data input 103 from the controller 100 to a driver 112 of a diode laser array 114 (e.g., 32 light sources in one example, such as a vertical-cavity surface-emitting laser (VCSEL) array, or an array of other light sources), as well as a magnification adjustment input 104a from the controller 100 for setting the spacing 404 between adjacent scan lines 400 and the swath spacing 402. In operation, a stream of image data 103 is provided via the controller 100 to the driver 112 associated with a single color portion of the next panel zone image, and the driver 112 modulates one or more of the diode lasers 114 to produce a modulated light output 122 in the form of 32 modulated light beams 122 in conformance with the input image data. The laser beam light outputs 122 pass into a first optical system with conditioning optics 124 and then illuminate a facet 126 of a rotating polygon 128 having a number of such facets 126 (eight in one example).

The light beams 122 are reflected from the facet 126 through a second optical system 130 to form a swath of scanned spots on the photosensitive image plane of the passing photoreceptor 4. The rotation of the facet 126 causes the spots to sweep across the image plane forming a succession of scan lines 400 oriented in a “fast scan” direction (e.g., generally perpendicular to a “slow scan” or process direction 4p along which the belt 4 travels). Movement of the belt 4 in the slow scan direction 4p is such that successive rotating facets 126 of the polygon 128 form successive scan lines 400 (or groups thereof) that are offset from each other (and from preceding and succeeding groups) in the slow scan (process) direction. Each such scan line 400 in this example consists of a row of pixels produced by the modulation of the corresponding laser beam 122 as the laser spot scans across the image plane, where the spot is either illuminated or not at various points as the beam scans across the scan line 400 so as to selectively illuminate or refrain from illuminating individual locations on the belt 4 in accordance with the input image.

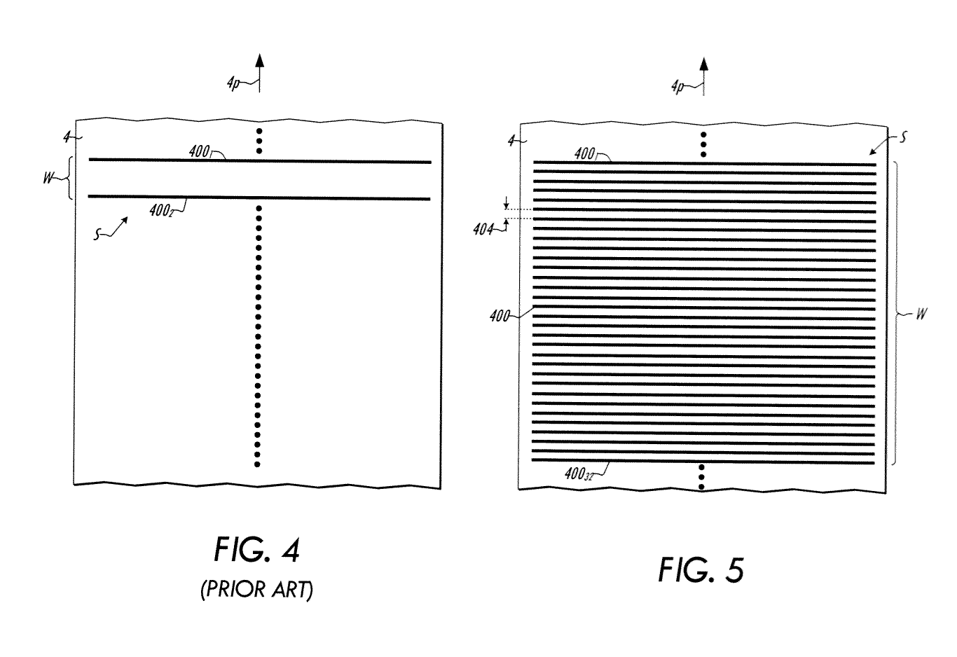

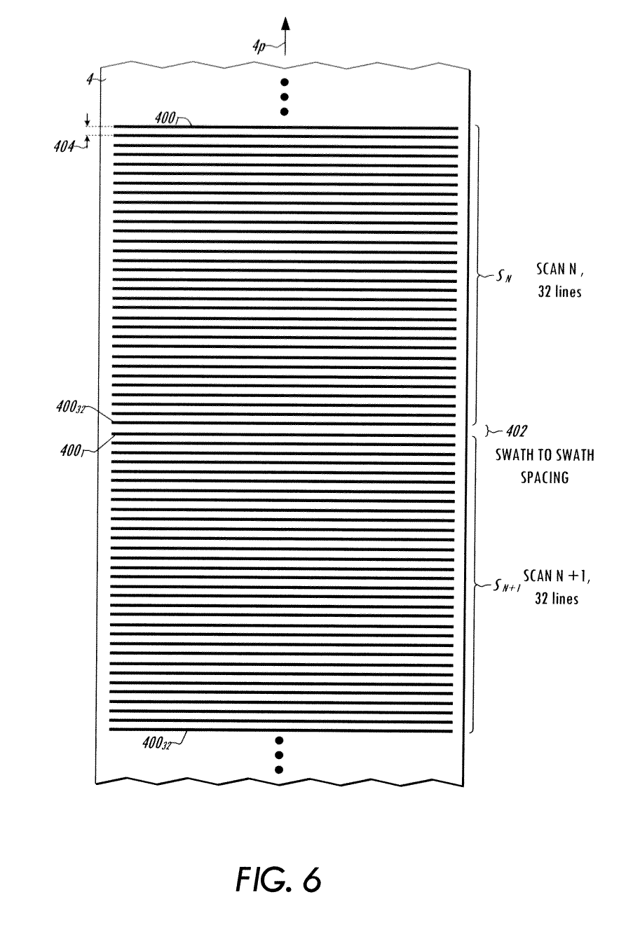

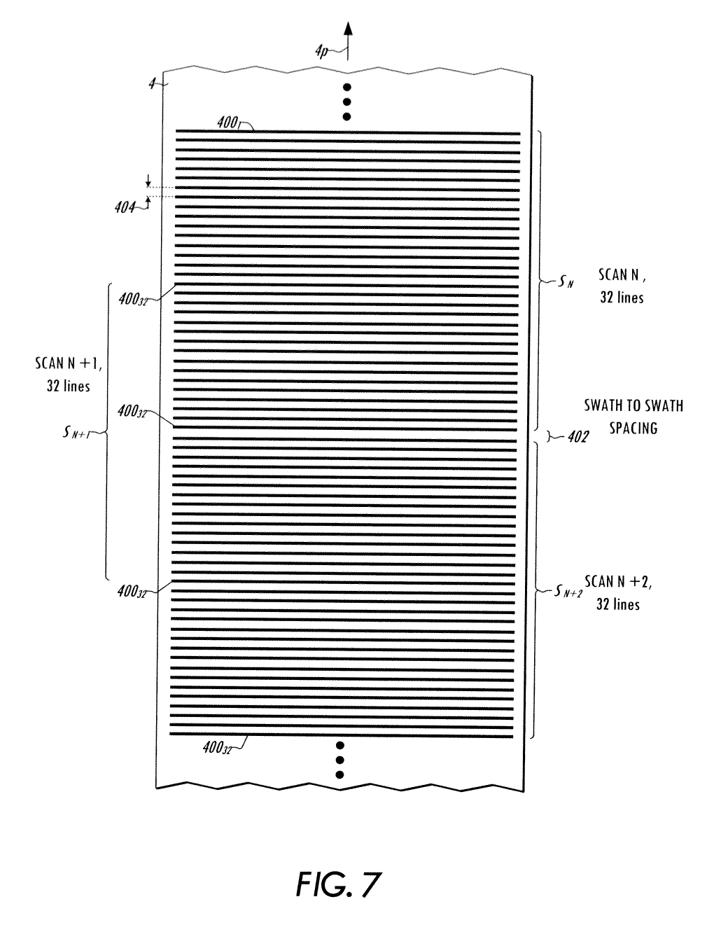

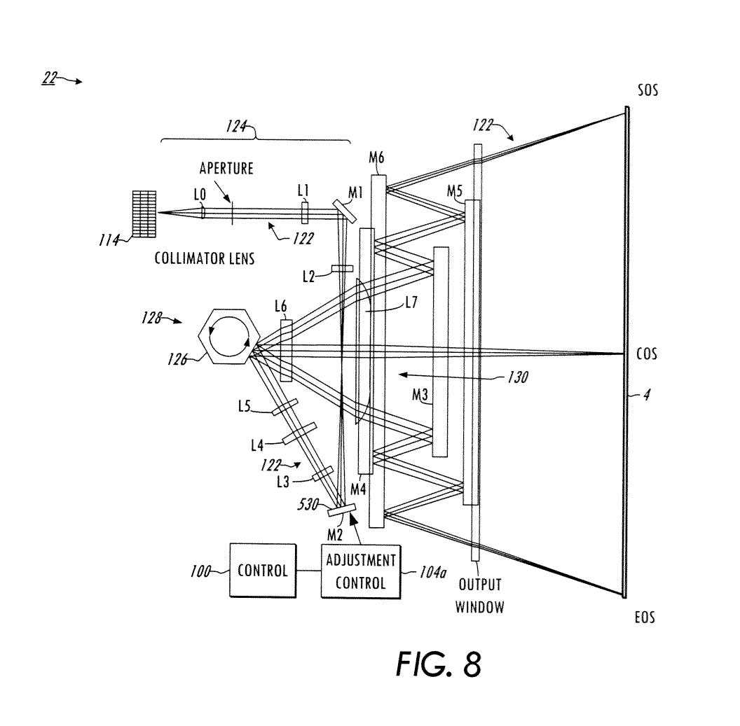

Referring to FIGS. 4-7, certain conventional dual beam raster output scanners (FIG. 4) created a pair of scan lines 400₁, 400₂ in each swath S having a swath width W in the process direction 4p, whereas newer multibeam raster output scanners create a large number of scan lines in each swath S with a much wider width W, where FIG. 5 shows an example having 32 such scan lines 400₁-400₃₂, with a line spacing 404. The wider swath S in FIG. 5 leads to several problems, one of which is stitching error. As seen in FIG. 6, consecutive scan swaths S_{N} and S_{N+1} may create problems and visually perceptible artifacts, if a swath-to-swath spacing 402 is significantly different from a line-to-line spacing 404. Very small spacing can cause bunching of the swaths S, whereas too much spacing may result in excess non-imaged area between the swaths S, and either of these situations can lead to image artifacts, including banding and beating. FIG. 7 illustrates another situation in which overwriting is used in conjunction with a 32-line raster output scanner 22. In this case, double overwriting is employed in which scan line 1 of a given swath overwrites scan line 17 of the preceding swath, scan line 2 overwrites the proceedings scan line 18, etc. As can be appreciated, line-to-line spacing 404, as well as swath-to-swath spacing 402 must be carefully controlled to avoid image defects when such overwriting is used with multiple beam raster output scanners 22.

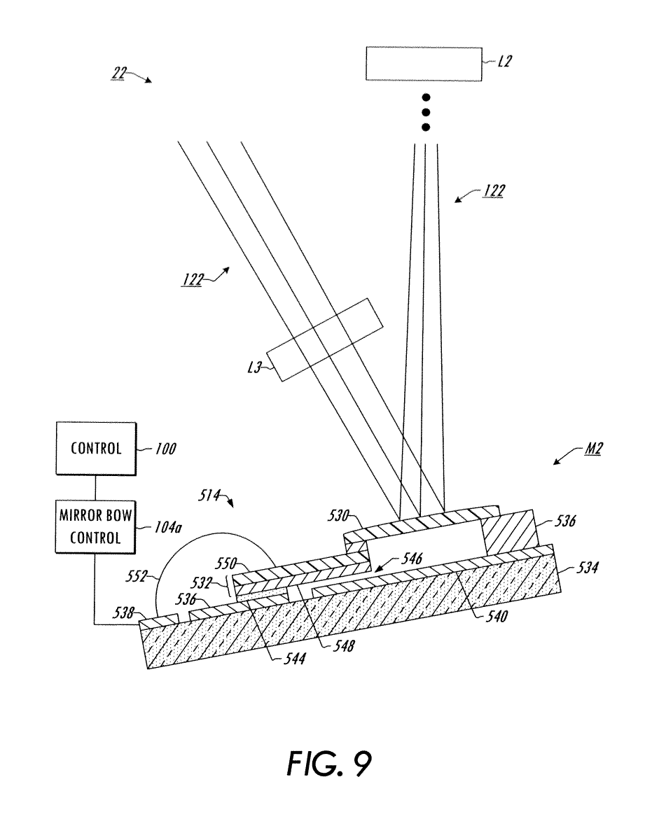

FIG. 8 illustrates an exemplary raster output scanner 22 in the system 2 of FIG. 1 above in which the controller 100 provides an adjustment control signal or value 104a to an adjustable mirror assembly M2 in a first optical system 124 between the laser array light source 114 and the rotating polygon 128. In this raster output scanner 22, the first optical system 124 collimates the plurality of light beams 122 received from the light source 114, and provides collimated light beams 122 to the rotating polygon 128. The mirrored facets 126 of the rotating polygon 128 deflect collimated light beams 122, and provide deflected light beams 122 to a second optical system 130 which focuses the deflected light beams 122 into a plurality of moving spots and directs the moving spots towards the photoreceptor 4 traveling in the process direction 4p.

The first and second optical systems 124 and 130, respectively, may each include one or more optical elements for modifying paths of the beams 122 and the relative spacing thereof, including without limitation mirrors and/or lenses. In the illustrated embodiment, the first optical system 124 (the pre-polygon system) includes a collimator lens L0 followed by an aperture and another lens L1, after which the beams are deflected by a first mirror M1 through a lens L2 to a second mirror M2. In this implementation, the second mirror M2 is adjustable, although other embodiments are possible in which the first mirror M1 is adjustable. The system 124 also includes three more focusing mirrors L3-L5 disposed between the second mirror M2 and the rotating polygon 128. After the light beams 122 are deflected by the polygon facets 126, they pass through a second optical system 130 including lens L6, lens L7, and mirrors M3-M6 as shown in the FIG. 8, before exiting through an output window as moving spots directed to an image area of the photoreceptor 4.

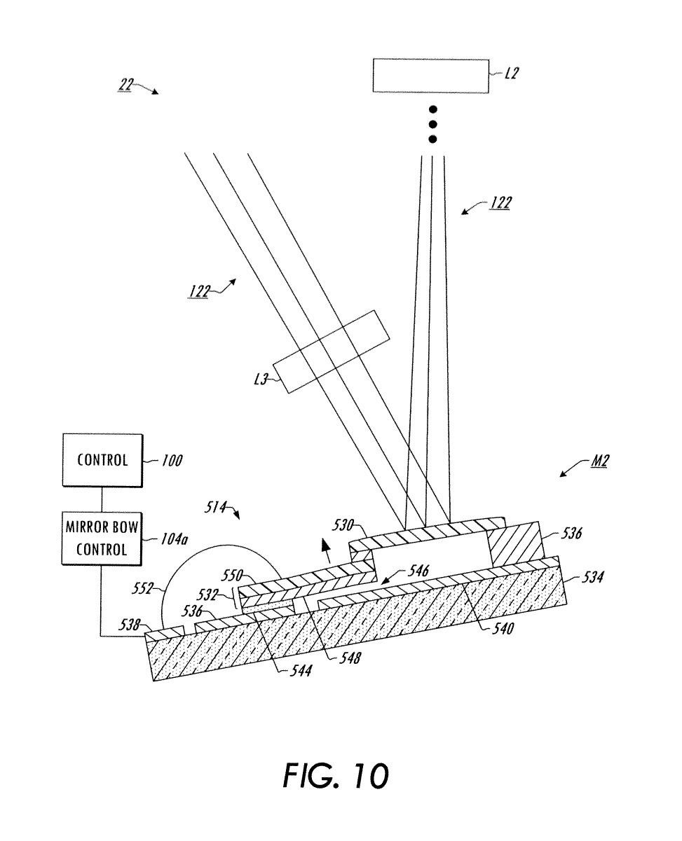

Referring also to FIGS. 9 and 10, in order to provide adjustability for line-to-line, as well as swath-to-swath spacing 404 and 402 in the raster output scanner 22, the controller 100 provides an electronic signal or value 104a to an electronic adjustment input of the adjustable mirror M2 in the first optical system 124. The controller 100 providing the signal 104a may be the overall system controller 100 providing such signals or values to multiple ROSs, or a spacing controller 100 may be provided as part of each ROS, where such localized spacing adjustment controllers may be themselves operated by a central controller 100 in certain embodiments. The illustrated mirror M2 includes a reflective surface 530 positioned in the optical system 124 to deflect a plurality of the light beams, 122, as well as an electronic adjustment input to change the position and/or shape of the reflective surface 530 relative to the paths of the beams 122 so as to increase or decrease the line-to-line spacing 404 (FIG. 7 above) and thus the swath-to-swath spacing 402 and the swath width W in the process direction 4p for the deflected light beams 122 impinging on the photoreceptor 4. Adjustment of either the shape or the positioning of the reflective mirror surface 530 can thus be used for any needed runtime spacing adjustments, even where the speed of the photoreceptor 4 is fixed.

In one embodiment, the controller 100 provides a single voltage signal 104a to the adjustable mirror M2 to set the line-to-line spacing 404, and holds this electrical signal 104a constant while the polygon 128 is rotated in operation. In an alternative implementation, the adjustable mirror M2 is provided with a digital value or command from the controller 100, by which the position and/or location of the mirrored surface 530 is set, and is maintained at this value while the polygon 128 rotates. The controller 100, in this regard, can programmatically adjust the spacing 402, 404, W, etc. based on measured characteristics of the printing operation of the system 2, and/or the controller 100 may be instructed to provide the adjustment control 104a by a user.

Referring also to FIGS. 9 and 10, the adjustable mirror M2 can be any suitable mirror assembly providing a reflective surface whose position and/or shape is changed or modified according to an electronic adjustment input, and which is situated within the raster output scanner 22 such that adjustment of the mirror position/shape increases or decreases the spacing 404 between adjacent light beams 122 in the process direction 4p at the photoreceptor 4. FIGS. 9 and 10 illustrate one such suitable adjustable mirror M2 that can be constructed using semiconductor fabrication techniques as described, for example, in U.S. Pat. No. 7,542,200, the entirety of which is hereby incorporated by reference. Thus constructed, the adjustable mirror M2 includes an assembly 514 with a low expansion ceramic substrate 534 upon which is formed to drive electrodes 536 and 538 as well as a capacitive sensing electrode 540. A solder bonding 544 is mounted in electrical contact with the first drive electrode 536 and in physical contact with the substrate 534. A laminated bending actuator 532 is mounted in cantilevered fashion to the solder bonding pad 544, and may be constructed of two layers 548 and 550 of PZT (lead-zirconate titanate) material with a shim material therebetween. The reflective surface of the mirror 530 in one example is flat, but maybe bowed in certain embodiments. In the illustrated embodiment, a convex bowed shape reflective surface 530 is provided by micro-machining silicon and mounting this to a distal end of bending actuator 532, with an opposite end of the mirror 530 being mounted to a support structure 536. In this orientation, a capacitive air gap 546 is provided between the bending actuator 532 and a capacitive sensing electrode 540.

In operation, the first drive electrode 538 is electrically connected to the upper layer 550 of the bending actuator 532 by an electrical lead 552, and the bending actuator 532 can be used by provision of a suitable electronic signal (e.g., voltage) to change the bow angle of the mirror 530 and/or its position relative to the beams 122. In particular, a voltage is applied by the controller 100 to the upper layer 550 via the second drive electrode 538 and the electrical lead 552, which causes a differential strain between the layers of the bending actuator 532. This strain causes the bending actuator 532 to deflect or rotate around its proximal end which is attached to the substrate 534 by the solder pad 544. This causes a change in the distance between the lower layer 548 of the bending actuator 532 and the capacitive sensing electrode 540. Thus, as further shown in FIG. 10, the distance in the capacitive gap 546 may be increased, thereby lifting the reflective surface 530 of the mirror M2, which also operates to change the bow angle of the reflective surface 530, thereby modifying the beam path of the light beams 122 and changing the spacing 404 between the scan lines on the photoreceptor 4.

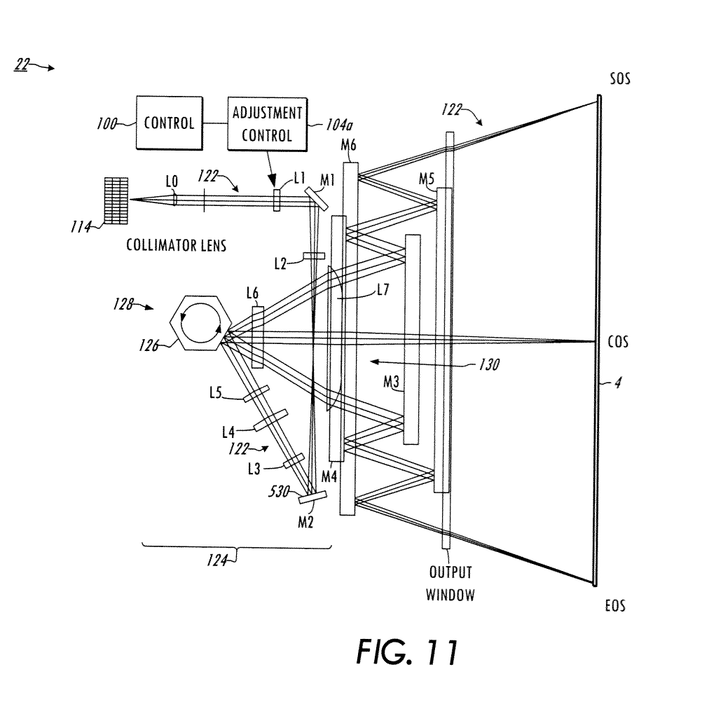

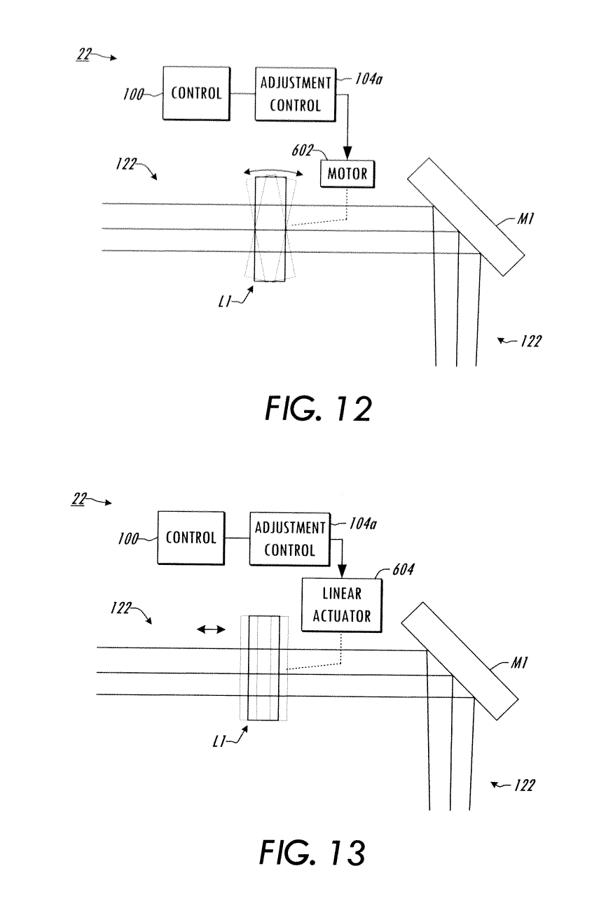

FIGS. 11-13 illustrate another exemplary raster output scanner 22 in the system of FIG. 1, in which an adjustable lens (in this case L1) is provided in the first optical system 124. The adjustable lens L1 includes an electronic adjustment input to change the position of the lens L1 so as to increase or decrease the line-to-line light beam spacing 404 (FIG. 7 above) in the process direction 4p at the photoreceptor 4. As seen in FIG. 11, the controller 100 provides an adjustment control signal or value 104a to the adjustable mirror L1 at run time to set the spacing 404, and the controller 100 holds the electronic signal or value 104a constant while the polygon 128 is rotated.

FIG. 12 shows one example in which the adjustable lens L1 includes a motor 602 operatively coupled with the lens L1 to change an incident angle at which the light beams 122 arrived at the lens L1 from the light source 114. By changing this rotational angle of the lens L1, the controller 100 can increase or decrease the scan line spacing 404 at the photoreceptor 4.

FIG. 13 shows yet another embodiment, in which the adjustable lens L1 includes a linear actuator 604 operatively coupled with the lens L1. The controller 100 in this case uses the adjustment control signal or value 104a to change the distance between the lens L1 and the light source 114 along the beam path of the light beams 122 so as to increase or decrease the scan line spacing 404 in the process direction 4p at the photoreceptor 4.

The above examples are merely illustrative of several possible embodiments of the present disclosure, wherein equivalent alterations and/or modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component, such as hardware, processor-executed software, or combinations thereof, which performs the specified function of the described component (i.e., that is functionally equivalent), even though not structurally equivalent to the disclosed structure which performs the function in the illustrated implementations of the disclosure. In addition, although a particular feature of the disclosure may have been disclosed with respect to only one of several embodiments, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising”. It will be appreciated that various of the above-disclosed and other features and functions, or alternatives thereof, may be desirably combined into many other different systems or applications, and further that various presently unforeseen or unanticipated alternatives, modifications, variations or improvements therein may be subsequently made by those skilled in the art which are also intended to be encompassed by the following claims.

1. A raster output scanner, comprising:
a light source operative to concurrently emit a plurality of light beams;
an optical system, comprising:
a first optical system operative to collimate the plurality of light beams received from the light source,
a rotating polygon having a plurality of mirrored facets operative to concurrently deflect the collimated light beams received from the first optical system,
a second optical system operative to focus the deflected light beams from the polygon into a plurality of moving spots and to direct the moving spots toward a photoreceptor travelling in a process direction, and
an adjustable mirror comprising:
a reflective surface positioned in the optical system to deflect the plurality of light beams, and
an electronic adjustment input to change at least one of a position and a shape of the reflective surface to increase or decrease a spacing between adjacent ones of the deflected light beams in the process direction at the photoreceptor; and
a controller operative to provide an electronic signal or value to the electronic adjustment input at run-time to set the spacing, the controller holding the electronic signal or value constant while the polygon rotates.

2. The raster output scanner of claim 1, where the adjustable mirror is in the first optical system.

3. The printing system of claim 13, where the reflective surface of the adjustable mirror has a convex shape.

4. The raster output scanner of claim 3, where the electronic adjustment input changes the shape of the reflective surface.

5. The printing system of claim 3, where the electronic adjustment input changes the position of the reflective surface.

6. The raster output scanner of claim 1, where the reflective surface of the adjustable mirror has a bowed shape.

7. The raster output scanner of claim 1, where the electronic adjustment input changes the shape of the reflective surface.

8. The raster output scanner of claim 1, where the electronic adjustment input changes the position of the reflective surface.

9. A raster output scanner, comprising:
a light source operative to concurrently emit a plurality of light beams;
an optical system, comprising:
a first optical system operative to collimate the plurality of light beams received from the light source, the first optical system comprising an adjustable lens including an electronic adjustment input to change a position of the adjustable lens to increase or decrease a spacing between adjacent light beams in the process direction at a photoreceptor; and
a rotating polygon having a plurality of mirrored facets operative to concurrently deflect the collimated light beams received from the first optical system,
a second optical system operative to focus the deflected light beams from the polygon into a plurality of moving spots and to direct the moving spots toward the photoreceptor travelling in a process direction; and
a controller operative to provide an electronic signal or value to the electronic adjustment input at run-time to set the spacing, the controller holding the electronic signal or value constant while the polygon rotates.

10. The raster output scanner of claim 9, where the adjustable lens comprises a motor operatively coupled with a lens to change an incident angle at which the plurality of light beams arrive at the lens from the light source to increase or decrease a spacing between adjacent ones of the deflected light beams in the process direction at the photoreceptor.

11. The raster output scanner of claim 9, where the adjustable lens comprises a linear actuator operatively coupled with a lens to change a distance between the lens and the light source along a path of the plurality of light beams to increase or decrease a spacing between adjacent ones of the deflected light beams in the process direction at the photoreceptor.

12. A printing system, comprising:
a photoreceptor moving in a process direction at a fixed speed;
a charging station operative to charge an exterior surface of an image area of the photoreceptor;
at least one raster output scanner operative to produce scan lines in a fast scan direction that is substantially perpendicular to the process direction, the raster output scanner comprising:
a light source operative to concurrently emit a plurality of light beams;
an optical system, comprising:
a first optical system operative to collimate the plurality of light beams received from the light source, the first optical system comprising an adjustable optical element operative according to an adjustment input to increase or decrease a spacing between adjacent light beams in the process direction at the photoreceptor,
a polygon rotating at a fixed speed and having a plurality of mirrored facets operative to concurrently deflect the collimated light beams received from the first optical system, and
a second optical system operative to focus the deflected light beams from the polygon into a plurality of moving spots and to direct the moving spots toward a photoreceptor travelling in a process direction, and
a controller operative to provide an electronic signal or value to the electronic adjustment input at run-time to set the spacing, the controller holding the electronic signal or value constant while the polygon rotates;
a developer operative to deposit toner onto a latent image to form a toner image in the image area of the photoreceptor;
a transfer station operative to transfer the toner image onto a substrate; and
a fusing station operative to fuse the toner image to the substrate.

13. The printing system of claim 12, where the adjustable optical element is an adjustable mirror comprising a reflective surface positioned in the first optical system to deflect the plurality of light beams, and an electronic adjustment input to change at least one of a position and a shape of the reflective surface to increase or decrease a spacing between adjacent ones of the deflected light beams in the process direction at the photoreceptor.

14. The printing system of claim 13, where the electronic adjustment input changes the shape of the reflective surface.

15. The printing system of claim 13, where the electronic adjustment input changes the position of the reflective surface.

16. The printing system of claim 13, where the reflective surface of the adjustable mirror has a bowed shape.

17. The printing system of claim 16, where the reflective surface of the adjustable mirror has a convex shape.

18. The printing system of claim 12, where the adjustable optical element is an adjustable lens including an electronic adjustment input to change a position of the adjustable lens to increase or decrease the spacing between adjacent ones of the deflected light beams in the process direction at a photoreceptor.

19. The printing system of claim 18, where the adjustable lens comprises a motor operatively coupled with a lens to change an incident angle at which the plurality of light beams arrive at the lens from the light source to increase or decrease a spacing between adjacent ones of the deflected light beams in the process direction at the photoreceptor.

20. The printing system of claim 18, where the adjustable lens comprises a linear actuator operatively coupled with a lens to change a distance between the lens and the light source along a path of the plurality of light beams to increase or decrease a spacing between adjacent ones of the deflected light beams in the process direction at the photoreceptor.
